(19) United States
(12) Patent Application Publication
(10) Pub. No.: US 2026/0137057 A1
(43) Pub. Date: May 21, 2026

(54) INTERCHANGEABLE PET BEDDING SYSTEM

(71) Applicant: Linda Tang, San Jose, CA (US)

(72) Inventor: Linda Tang, San Jose, CA (US)

(21) Appl. No.: 19/392,029

(22) Filed: Nov. 17, 2025

Related U.S. Application Data
(60) Provisional application No. 63/721,557, filed on Nov. 17, 2024.

(51) Int. Cl. A01K 1/035

(52) U.S. Cl. CPC A01K 1/0353

(57) ABSTRACT

Various embodiments relate to a modular bed including a base pad containing a filler material within a mesh fabric; a removable base pad cover having an opening along at least one side, the base pad being removably enclosed therein; and an anti-slip cover comprising a primary cover material and an elastic secondary cover material disposed across portions of each of a plurality of corners of the anti-slip cover to enhance friction. The elastic secondary cover material provides secure retention of the anti-slip cover on a supporting surface.

### FIELD OF INVENTION

The present disclosure relates to a pet bedding system, and more particularly, a pet bedding system for promoting sustainability within the outdoor apparel industry while reducing the carbon footprint of the veterinary and pet care sectors.

### INTRODUCTION

One major problem in veterinary clinics is that clients never see the treatment rooms. This is typically because these areas are unkempt and filled with laundry. Most clinics rely solely on cotton towels for a variety of tasks. After their exam, pets are taken to the treatment room, usually placed in a holding cage. Often made of stainless steel, these cages only have a towel laid down for comfort. Unfortunately, pets frequently push these towels aside and sit directly on the metal, contributing to inefficiency. This practice stems from what veterinarians are taught in school and the ease/low cost of acquiring donated cotton bath towels.

Typically, small veterinary practices handle an average of five loads of laundry per day, which leads to frequent breakdowns of their washers and dryers—often once a year or every couple of years. Around 5% of landfill waste is alarmingly from “white appliance” waste-large household appliances like refrigerators, washing & drying machines, dishwashers, ovens, and air conditioners. Disposal of white appliances leads to toxic materials (like refrigerants and heavy metals) leaking into the environment, contributing to pollution and greenhouse gas emissions. Furthermore, these practices can spend upwards of $15,000 annually on laundry expenses due to their choice of materials. For example, clinics are paying substantial money to maintain their “free cotton towels.”

Laundering large cotton towels consumes significant resources. According to the EPA, commercial laundering facilities use approximately 3 gallons of water per pound of laundry. Large cotton towels can weigh 2 pounds each, driving up water and energy costs with each wash.

Further, cotton towels degrade quickly, with repeated washing causing fabric breakdown, color fading, and fiber weakening, especially when exposed to bleach and disinfectants. Mismatched, stained, or torn towels contribute to a disorganized and unprofessional environment, negatively impacting client perception.

Accordingly, it is desirable to have a hygienic pet bed that is easy to wash without being burdensome on existing washers and dryers.

### SUMMARY

In some aspects, the techniques described herein relate to a modular bed, including: a base pad including a filler material, wherein the filler material is contained within a mesh fabric; a removable base pad cover including an opening along at least one side of the removable base pad cover, wherein the base pad is removably enclosed within the removable base pad cover; an anti-slip cover including a primary cover material and a secondary cover material, wherein the secondary cover material is disposed across at least a portion of each of a plurality of corners of the anti-slip cover, and wherein the secondary cover material is elastic.

In some aspects, the techniques described herein relate to a modular bed, further including an anti-slip mat including a top and a bottom surface, wherein the bottom surface includes a friction-enhancing material disposed across at least a portion of a surface area of the bottom surface.

In some aspects, the techniques described herein relate to a modular bed, wherein the anti-slip mat abuts a bottom surface of the base pad cover.

In some aspects, the techniques described herein relate to a modular bed, wherein the anti-slip mat abuts a top surface of the base pad cover.

In some aspects, the techniques described herein relate to a modular bed, wherein the anti-slip mat abuts a top surface of the anti-slip cover.

In some aspects, the techniques described herein relate to a modular bed, wherein the anti-slip mat abuts a bottom surface of the anti-slip cover and a top surface of the base pad cover.

In some aspects, the techniques described herein relate to a modular bed, including: a base pad including a filler material, wherein the filler material is contained within a mesh fabric; a removable base pad cover including an opening along at least one side of the removable base pad cover, wherein the base pad is removably enclosed within the removable base pad cover; an anti-slip cover including a primary cover material and a secondary cover material, wherein the secondary cover material is disposed across at least a portion of each of a plurality of corners of the anti-slip cover, and wherein the secondary cover material is elastic; one or more bordering members removably disposed along a perimeter of the modular bed; and an anti-slip mat including a top and bottom surface, wherein the bottom surface includes a friction-enhancing material disposed across at least a portion of a surface area of the bottom surface, wherein the anti-slip mat abuts a bottom surface of the base pad cover, a top surface of the base pad cover, a top surface of the anti-slip cover, or a bottom surface of the anti-slip cover and a top surface of the base pad cover.

In some aspects, the techniques described herein relate to a modular bed, wherein the bordering members form a wall including one or more means of attachment disposed on at least one end of each bordering member.

In some aspects, the techniques described herein relate to a modular bed, including: a base pad including a filler material, wherein the filler material is contained within a mesh fabric; a removable base pad cover including an opening along at least one side of the removable base pad cover, wherein the base pad is removably enclosed within the removable base pad cover; an anti-slip cover including a primary cover material and a secondary cover material, wherein the secondary cover material is disposed across at least a portion of each of a plurality of corners of the anti-slip cover, and wherein the secondary cover material is elastic; and one or more bordering members removably disposed along a perimeter of the modular bed.

In some aspects, the techniques described herein relate to a modular bed, wherein the bordering members form a wall including one or more means of attachment disposed on at least one end of each bordering member.

### BRIEF DESCRIPTION OF THE DRAWINGS

The accompanying drawings, which are incorporated in and constitute a part of this specification, illustrate exemplary embodiments of the present disclosure and, together with the detailed description, serve to explain the principles of the disclosure.

FIGS. 1A and 1B illustrate an embodiment of the modular bed.

FIG. 2 illustrates an embodiment of the base pad including an insulative cushion member contained within a mesh fabric.

FIG. 3 illustrates an embodiment of the anti-slip cover.

FIG. 4 illustrates an embodiment of the bottom of the anti-slip cover for use as a quick release, detachable, and anti-slip cover for the modular bed (the base pad and the removable base pad cover).

FIG. 5 illustrates an anti-slip according to aspects of the present disclosure.

FIG. 6 illustrates an embodiment of detachable and modular bolsters.

FIG. 7 illustrates an embodiment of modular walls removably disposed along the perimeter of the modular bed.

### DETAILED DESCRIPTION

In the following detailed description, reference will be made to the accompanying drawing(s), in which identical functional elements are designated with like numerals. The accompanying drawings show by way of illustration, and not by way of limitation, specific aspects, and implementations consistent with the principles of this disclosure. These implementations are described in sufficient detail to enable those skilled in the art to practice the disclosure, and it is to be understood that other implementations may be utilized, and that structural changes and/or substitutions of various elements may be made without departing from the scope and spirit of this disclosure. The following detailed description is, therefore, not to be construed in a limited sense.

The present disclosure relates to a modular bed 100. The modular bed 100 may include a base pad 102, a removable base pad cover 104, an anti-slip cover 106, one or more bordering members 108, and/or an anti-slip mat 110. The modular bed 100 may be designed to fit standardized sizes commonly found in veterinary cages and kennels.

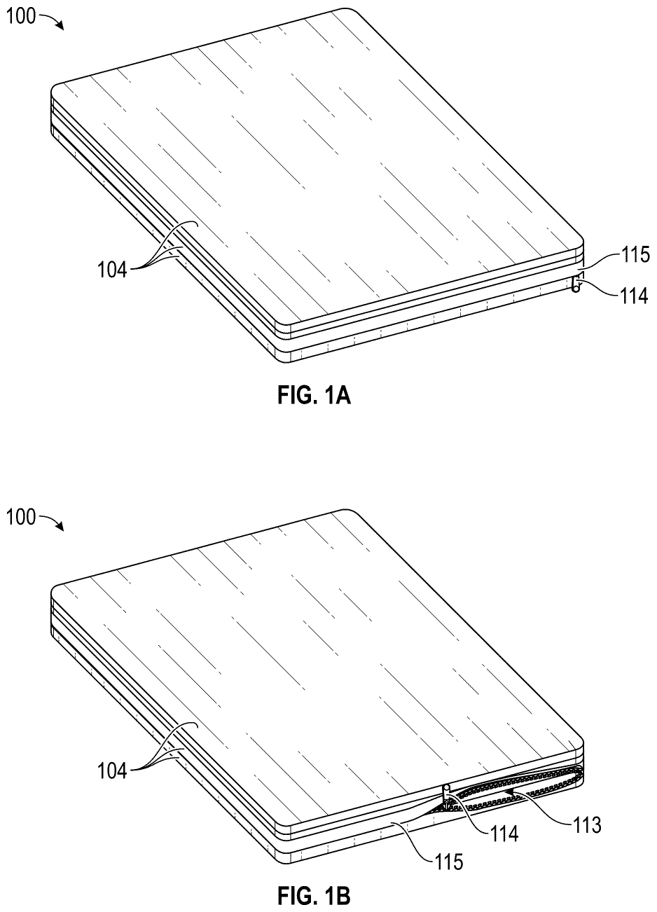

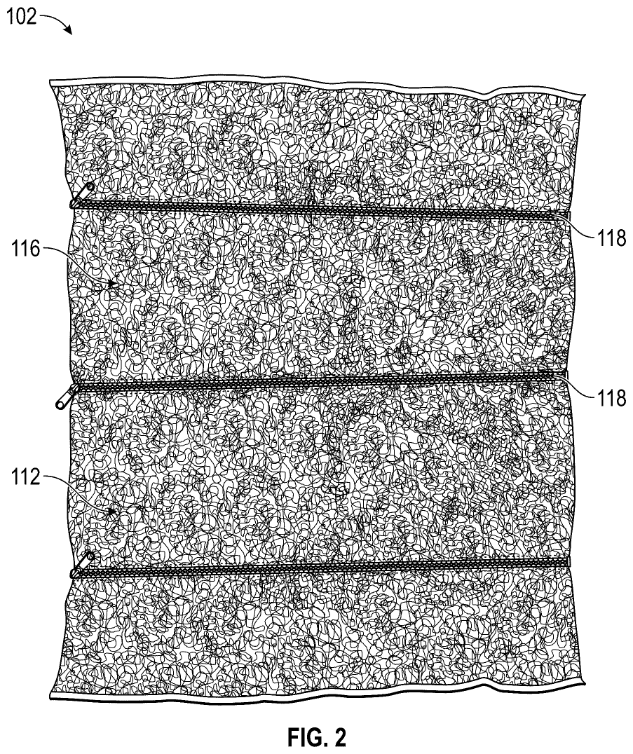

As illustrated in FIG. 1A and FIG. 1B, an embodiment of the modular bed 100 comprises the base pad 102 and removable base pad cover 104. The base pad 102 may be contained within a removable base pad cover 104. The base pad 102 may include an insulative cushioned member 112 configured to support the weight of an animal, such as a dog or cat, as shown and discussed further in the description for FIG. 2. The insulative cushion member 112 may comprise a single, unibody piece of material, or a plurality of filler material pieces, such as foam or fabric strips.

For example, the removable base pad cover 104 may include a storm flap zipper 114 configured to enable access to an interior of the base pad cover 104 via an opening 113. The opening 113 may be disposed along at least one side of the removable base pad cover 104 to facilitate the easy insertion and removal of the base pad 102. As illustrated in FIG. 1A, the storm flap zipper 114 may include a storm flap, which may include a piece of fabric 115 extending along the opening 113 and configured to cover the opening 113 when the opening 113 is in a closed position. In an embodiment, the piece of fabric 115 may have a length sufficient to cover the width of the storm flap zipper 114. In another embodiment, the piece of fabric 115 may have a length longer than the width of the storm flap zipper 114, or any suitable width as may be known to one of ordinary skill in the art. The storm flap zipper 114 and opening 113 allow every part of the modular bed 100, except for the high-density foam (which is wipeable), to be machine-washed or wiped clean and may help protect the inner baffle or foam from outside liquids and biohazards.

As illustrated in FIG. 1B, the opening 113 may be revealed when the storm flap zipper 114 is unzipped into an open position on at least one side of the removable base pad cover 104. The opening 113 may be approximately equal to or greater than the width of the base pad 102 to facilitate easy insertion and removal.

FIG. 2 illustrates an embodiment of the base pad 102 which may include the insulative cushion member 112 contained within a mesh fabric 116. The insulative cushion member 112 may comprise a single, unibody piece of material, or a plurality of filler material pieces, such as foam or fabric strips. In an embodiment, the mesh fabric 116 includes an internal baffle structure 118 configured to maintain a substantially uniform distribution of said insulative cushion member 112 when subjected to dynamic loading conditions caused by animal movement. The internal baffle structure 118 may comprise flexible enclosures positioned within the interior cavity of the mesh fabric formed by coupling the inner surfaces of the mesh fabric 116 at a plurality of locations. The mesh fabric 116 may be waterproof.

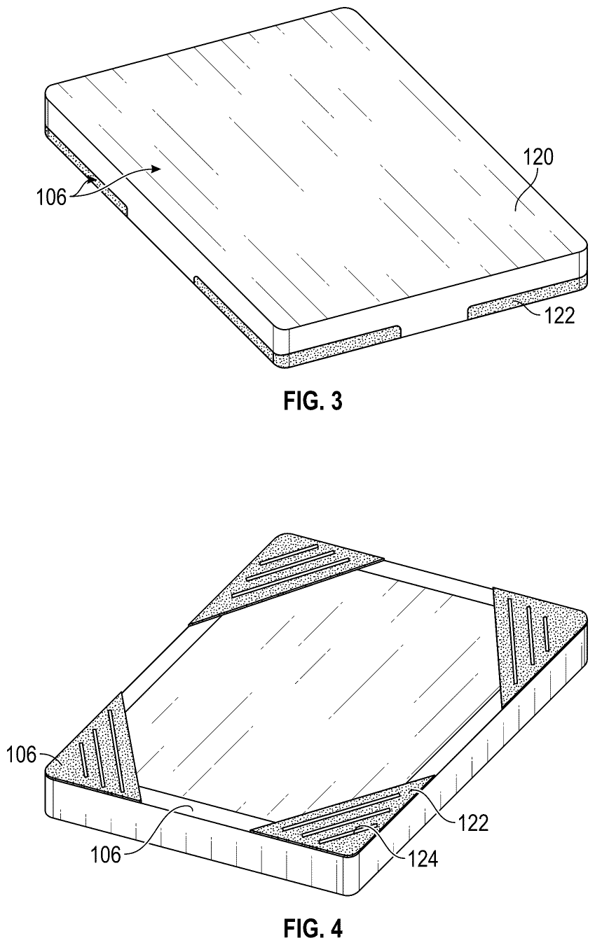

FIG. 3 illustrates an embodiment of the top of the anti-slip cover 106 for use as a quick release, detachable, and anti-slip cover for the modular bed 100 (the base pad 102 and the removable base pad cover 104). In various embodiments, the anti-slip cover 106 may be selectively cut at different dimensions to accommodate various cage or examination table dimensions. In one embodiment, the anti-slip cover 106 comprises detachable modular bolsters, walls, covers, and/or mats.

In an embodiment, the anti-slip cover 106 may comprise a primary material 120 and a secondary material 122 disposed across at least a portion of each of a plurality of corners of the anti-slip cover and is elastic. In some embodiments, the primary material 120 may be made from 200D waterproof nylon or quick-dry polyester medium pile brushed fleece. The anti-slip cover 106 is designed for quick-change operation (removal and replacement), with elastic retention for a secure but flexible fit.

In an embodiment, the primary material 120 is asymmetrically configured of two different materials on opposite sides such that it is reversible between a quick-dry polyester medium pile brushed fleece surface and a smooth fleece surface. The brushed fleece surface may prioritize insulation and comfort while the smooth fleece surface may prioritize fur-resistance and easy cleaning.

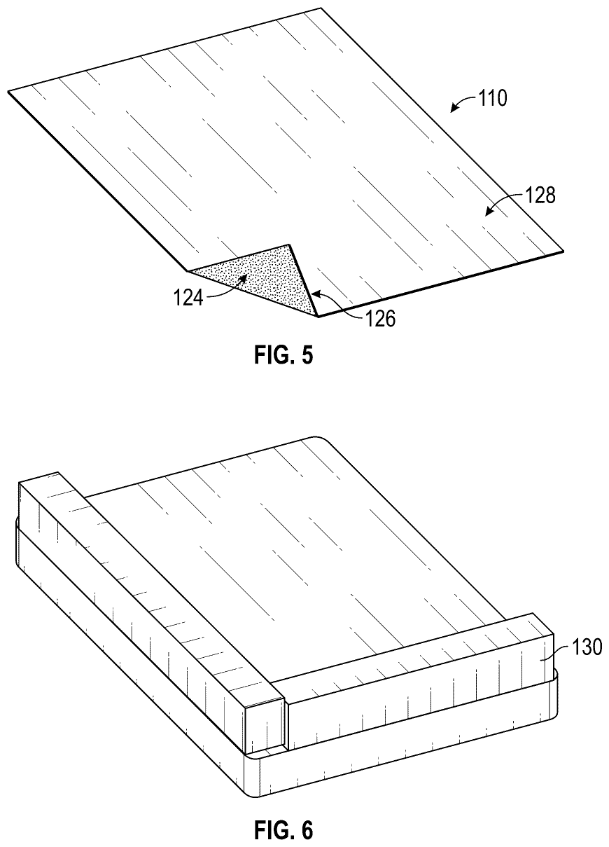

FIG. 4 illustrates an embodiment of the bottom of the anti-slip cover 106 for use as a quick release, detachable, and anti-slip cover for the modular bed 100 (the base pad 102 and the removable base pad cover 104). In some embodiments, the secondary material 122 may comprise friction-enhancing material such as polyurethane bonding 124 on power mesh nylon. This material is machine washable and may provide double tensile strength and waterproofing, making the product multifunctional as a reusable pee pad.

FIG. 5 illustrates an anti-slip mat 110 which may comprise anti-slip polyurethane bonding 124 disposed across at least a portion of the bottom surface of the anti-slip mat 126. This material is machine washable, and may provide double tensile strength, waterproofing, and insulation, making the product multifunctional as a reusable pee pad or warming blanket. The top surface material of the anti-slip mat 128 is also waterproof and insulated.

In one embodiment the anti-slip mat 110 may abut the top surface of the removable base pad cover 104 via the anti-slip polyurethane bonding 124. In another embodiment, the anti-slip mat 110 may abut the top surface of the anti-slip cover 106. In yet another embodiment, the anti-slip mat 110 may abut the bottom surface of the anti-slip cover 106 and the top surface of the removable base pad cover 104. In various embodiments, the anti-slip mat 110 may be selectively cut at different dimensions to accommodate various cage or examination table dimensions.

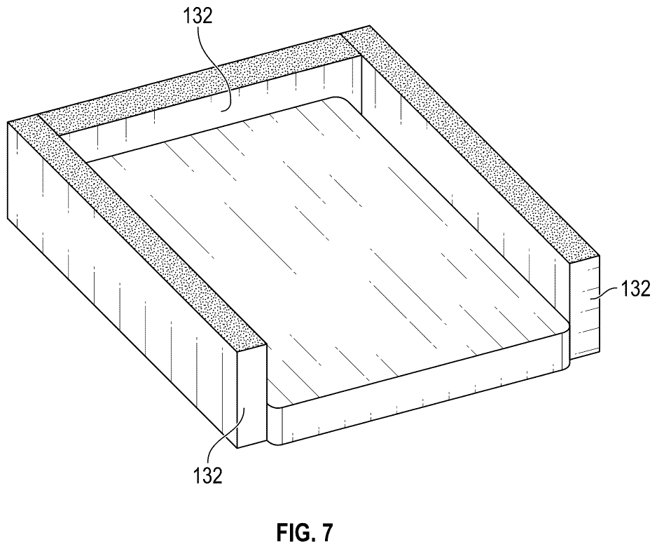

FIGS. 6 and 7 illustrate embodiments where one or more bordering members may be removably disposed along the perimeter of the modular bed 100 to provide customizable support.

FIG. 6 illustrates an embodiment of detachable and modular bolsters 130 that may be removably disposed along the perimeter of the modular bed 100. In an embodiment, the modular bolsters 130 may be removably disposed along the perimeter of the anti-slip cover 106. In some embodiments, the modular bolsters 130 may have a length that is proportional to, equal to, or greater than the length of one or more sides of the modular bed 100. The bordering members allow veterinarians to customize comfort pads according to specific needs of the animals before or after surgery and to tailor the environment for pet patients in the clinic. Additionally, it enables the replacement of individual components rather than necessitating an entire bedding set overhaul, thereby extending the product's lifespan and reducing costs associated with frequent replacements.

FIG. 7 illustrates an embodiment of modular walls 132 that may be removably disposed along the perimeter of the modular bed 100. In another embodiment, the modular walls 132 may be removably disposed along the perimeter of the anti-slip cover 106. The modular walls 132 may be connected together upright to build a cushion barrier against the steel cage walls. In one embodiment, the modular walls 132 may include one or more means of attachment disposed on at least one end of each modular wall 132, such as male and female snaps, buttons, or hook and loop. In some embodiments, the modular walls 132 may have a length that is proportional to, equal to, or greater than the length of one or more sides of the modular bed 100 and a height that may accommodate different standard cage heights.

Finally, other implementations of the disclosure will be apparent to those skilled in the art from consideration of the specification and practice of the disclosure disclosed herein. It is intended that the specification and examples be considered as exemplary only. The true scope and spirit of the disclosure are indicated by the following claims.

What is claimed is:

1. A modular bed, comprising:
a base pad including a filler material, wherein the filler material is contained within a mesh fabric;
a removable base pad cover including an opening along at least one side of the removable base pad cover,
wherein the base pad is removably enclosed within the removable base pad cover;
an anti-slip cover including a primary cover material and a secondary cover material,
wherein the secondary cover material is disposed across at least a portion of each of a plurality of corners of the anti-slip cover, and
wherein the secondary cover material is elastic.

2. The modular bed of claim 1, further including an anti-slip mat including a top and a bottom surface, wherein the bottom surface includes a friction-enhancing material disposed across at least a portion of a surface area of the bottom surface.

3. The modular bed of claim 2, wherein the anti-slip mat abuts a bottom surface of the base pad cover.

4. The modular bed of claim 2, wherein the anti-slip mat abuts a top surface of the base pad cover.

5. The modular bed of claim 2, wherein the anti-slip mat abuts a top surface of the anti-slip cover.

6. The modular bed of claim 2, wherein the anti-slip mat abuts a bottom surface of the anti-slip cover and a top surface of the base pad cover.

7. A modular bed, comprising:
a base pad including a filler material, wherein the filler material is contained within a mesh fabric;
a removable base pad cover including an opening along at least one side of the removable base pad cover,
wherein the base pad is removably enclosed within the removable base pad cover;
an anti-slip cover including a primary cover material and a secondary cover material,
wherein the secondary cover material is disposed across at least a portion of each of a plurality of corners of the anti-slip cover, and
wherein the secondary cover material is elastic;
one or more bordering members removably disposed along a perimeter of the modular bed; and
an anti-slip mat including a top and bottom surface,
wherein the bottom surface includes a friction-enhancing material disposed across at least a portion of a surface area of the bottom surface,
wherein the anti-slip mat abuts a bottom surface of the base pad cover, a top surface of the base pad cover, a top surface of the anti-slip cover, or a bottom surface of the anti-slip cover and a top surface of the base pad cover.

8. The modular bed of claim 7, wherein the bordering members form a wall including one or more means of attachment disposed on at least one end of each bordering member.

9. A modular bed, comprising:
a base pad including a filler material, wherein the filler material is contained within a mesh fabric;
a removable base pad cover including an opening along at least one side of the removable base pad cover,
wherein the base pad is removably enclosed within the removable base pad cover;
an anti-slip cover including a primary cover material and a secondary cover material,
wherein the secondary cover material is disposed across at least a portion of each of a plurality of corners of the anti-slip cover, and
wherein the secondary cover material is elastic; and
one or more bordering members removably disposed along a perimeter of the modular bed.

10. The modular bed of claim 9, wherein the bordering members form a wall including one or more means of attachment disposed on at least one end of each bordering member.
